(19) United States
(12) Patent Application Publication
(10) Pub. No.: US 2025/0202407 A1
(43) Pub. Date: Jun. 19, 2025

(54) PANEL RAIL FOR A SOLAR MOUTING ASSEMBLY

(71) Applicant: KLOECKNER METALS CORPORATION, Roswell, GA (US)

(72) Inventors: Jeremy Jacobs, Sacramento, CA (US); Michael Start, Mountain View, CA (US); Jordan Mast, Placerville, CA (US); Mark Schroeder, Rancho Cordova, CA (US)

(21) Appl. No.: 18/986,480

(22) Filed: Dec. 18, 2024

Related U.S. Application Data
(60) Provisional application No. 63/611,307, filed on Dec. 18, 2023.

(51) Int. Cl. H02S 20/20

(52) U.S. Cl. CPC H02S 20/20

(57) ABSTRACT

A panel rail for a solar mounting system is provided. The panel rail has a front bracket having a front wing portion, a front mounting slot positioned proximate top end of the front wing portion, a back bracket having a back wing portion, a back mounting slot positioned proximate top end of the back wing portion, and a bottom rung positioned at a bottom portion of the panel rail, wherein the bottom rung is configured to engage a torque tube, a side portion extending upwardly from the bottom rung, wherein the side portion is coupled to each of the front wing portion and back wing portion, and wherein the side portion comprises a bolt hole, wherein the side portion is configured to accept a bolt through the boat holes to engage a torque tube, and wherein the mounting slots are configured to connect a solar module to the panel rail.

### CROSS REFERENCE TO RELATED APPLICATION

This application claims the benefit of U.S. Provisional Patent Application Ser. No. 63/611,307 filed Dec. 18, 2023, entitled Panel Rail for a Solar Mounting Assembly, the entire contents of which are incorporated by reference herein for all purposes.

### TECHNICAL FIELD

The present application generally relates to mounting systems for solar panels. More specifically, the present application relates to a panel rail for solar mounting systems that track the movement of the sun by varying tilt angles throughout the day to increase the energy output because the solar panels receive the most possible exposure.

### BACKGROUND

Renewable energy sources have been increasingly seen as the solution to meeting growing energy demands while reducing greenhouse gas emissions and dependence on fossil fuels. Solar energy is a viable solution to meeting the ever-increasing demand for energy. The use of solar cells or photovoltaic cells is one method of harnessing the sun's energy. The solar cell is a device that converts light energy into electrical energy by the photovoltaic effect.

A solar tracker is a device that adjusts the direction of a solar panel according to the position of the sun in the sky. By keeping the panel perpendicular to the sun, more sunlight strikes the solar panel, less light is reflected, and as a result, more energy is absorbed. That energy can then be converted into power. It is understood that these devices change their orientation throughout the day in accordance with the position of the sun in order to maximize the overall efficiency of the energy captured. Since the sun's position in the sky changes with the seasons and the time of day, trackers are used to align the collection system to maximize energy production.

A typical solar tracker includes a solar panel assembly or solar module mounted to a support structure such as a post secured to the ground. There are many types of solar modules, some of which may require custom panel rail solutions. For example, recent iterations of solar modules use glass or film glued to two individual steel rails. In this example, in order to be compatible with on-market solar tracking assemblies, custom solutions must be utilized, which may be expensive and ergonomically difficult to install. The solutions today use multi-piece panel rail assemblies that are cumbersome to install.

In light of all the above-mentioned drawbacks, there is a need for a solar panel rail that obviates these drawbacks.

### SUMMARY

The present disclosure describes embodiments of a panel rail for a solar mounting systems that utilize thin film solar modules. Thin film solar modules are a type of solar module or cell made by depositing one or more thin layers (thin films or TFs) of photovoltaic material onto a substrate, such as glass, plastic or metal. The modules require costlier rail assemblies due to their form factor. In some cases, custom steel rails adhered to the glass are used instead of industry standard aluminum frames.

In embodiments, the panel rails and is a single piece, stamped rail that holds a torque tube and is secured via a single bolt along the top surface of the torque tube. The bolt is located at eye level and thus is more ergonomic to install than designs that require securing the fastener below the torque tube.

Advantageously, the cost of manufacture is less in part due to less material. Furthermore, because it is entirely one stamped piece, it does not require pre-assembly in the factory or the field prior to being attached to the torque tube.

Advantageously, the panel rail has fewer parts known past rails leasing to lower costs, can have the bolt be pre-assembled to speed up installation even further, uses rapid wedge fasteners to secure the modules, is lighter weight than traditional rail assemblies, has integrated wire management holes, and secures to the torque tube with a single carriage bolt fastener (carriage bolts engage with the square hole and do not spin, so no need to use an additional wrench when installing to hold it in place).

In embodiments, a panel rail for a solar mounting system is described. The panel rail has a bracket configured to connect to a solar module, a bottom rung configured to accept a toque tube, and a bolt positioned at a top end of the bracket, wherein the bracket is configured to fasten a solar module to panel rail, and the bottom rung and bolt are configured to secure a torque tube.

In embodiments, a panel rail for a solar mounting system is described. The panel rail comprising a single-piece construction bracket comprising front and back brackets configured to connect to a solar module or the rails of a think film solar module.

In embodiments a panel rail for a solar mounting system is provided. The panel rail comprises a front bracket, wherein the front bracket comprises, a front wing portion, a front mounting slot positioned proximate top end of the front wing portion, a back bracket, wherein the back bracket comprises, a back wing portion, a back mounting slot positioned proximate top end of the back wing portion, a bottom rung positioned at a bottom portion of the panel rail, wherein the bottom rung is configured to engage a torque tube, a side portion extending upwardly from the bottom rung, wherein the side portion is coupled to each of the front wing portion and back wing portion, and wherein the side portion comprises a bolt hole, wherein the side portion is configured to accept a bolt through the boat holes to engage a torque tube, and wherein the mounting slots are configured to connect a solar module to the panel rail.

In embodiments, the front wing comprises a front left wing and a front right wing, the front right wing comprises the front mounting slot, and a front left mounting slot, the back wing comprises a back left wing and a back right wing, the back right wing comprises a back right mounting slot, and a back left mounting slot, and the mounting slots are configured accept a wedge clip, wherein the wedge clip is configured to couple the solar module the rail. In embodiments, the front bracket and backet bracket comprise upper contours that are shaped to further engage the torque tube.

In embodiments, the front bracket and back bracket both comprise a plurality of holes, and wherein the holes are configured to manage wires of an electrical assembly of the solar modules.

In embodiments, the side portion comprises a first side portion and a second side portion, each of which extends from the bottom rung, and wherein the second side portion comprises a second bolt hole configured to accept the bolt to engage the torque tube. The first side portion and second side portion are sandwiched by the front bracket and back bracket and have a predetermined depth, and wherein each of the wing portions extend outwardly from the side portions to form a space between each of the front bracket wings and back bracket rings. In embodiments, the first and second bolt holes are square shaped, and wherein the bolt comprises a carriage bolt.

In embodiments, the front left mounting slot is congruent with and in a same plane with the back left mounting slot, the front right mounting slot is congruent with and in a same plane with the back right mounting slot, wherein the front right mounting slot and back right mounting slot is configured to accept a second wedge clip, wherein the second wedge clip is further configured to accept a second wedge clip, wherein the second wedge clip is configured to further couple the solar module the rail. The wedge clip has a sloped point on one side and is conjured to provide an interference fit to secure the rail to the solar module.

In embodiments, the a plurality of panel rails may be used with a solar power farm.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF FIGURES

Aspects of the present disclosure are illustrated by way of example and are not limited by the accompanying figures for which like references indicate like elements.

FIG. 1 illustrates a front view of a panel rail for a solar mounting rack in accordance with one embodiment;

FIG. 2 illustrates a side view of a panel rail for a solar mounting rack in accordance with one embodiment;

FIG. 3 illustrates a perspective view of a panel rail for a solar mounting rack in accordance with one embodiment;

FIG. 4 illustrates a front view of a panel rail together with a torque tube and solar module on a solar mounting rack in accordance with one embodiment;

FIG. 5 illustrates a side view of a panel rail together with a torque tube and solar module on a solar mounting rack in accordance with one embodiment;

FIG. 6 illustrates a bottom perspective view of a panel rail together with a solar module in accordance with one embodiment; and

FIG. 7 illustrates a side view of a panel rail together with a solar module in accordance with one embodiment.

### DETAILED DESCRIPTION

Exemplary embodiments are discussed below with reference to the Figures.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub combinations of the disclosed features and/or combinations and sub combinations of several further features disclosed above. In addition, the logic flows depicted in the accompanying figures and/or described herein do not necessarily require the particular order shown, or sequential order, to achieve desirable results. Other implementations may be within the scope of the following claims.

The described embodiments are to be considered in all respects only as illustrative and not restrictive. The scope is, therefore, indicated by the appended claims rather than by the foregoing description. All changes that come within the meaning and range of equivalency of the claims are to be embraced within their scope.

While the present disclosure is described in relation to solar mounting system that utilize thin film solar cells, the rail may be utilized with other types of solar cells as well.

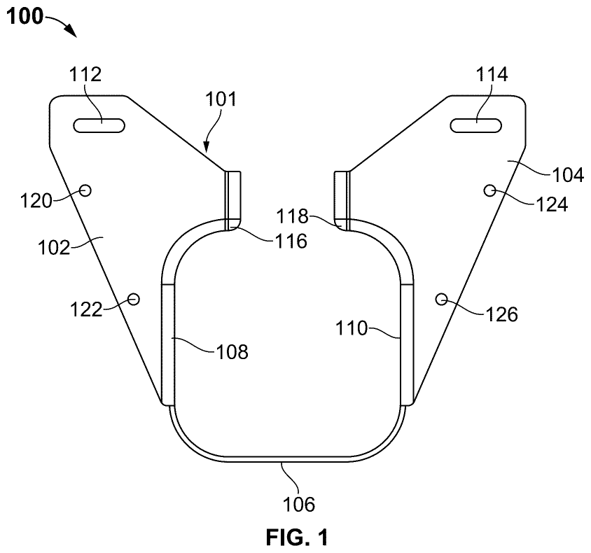

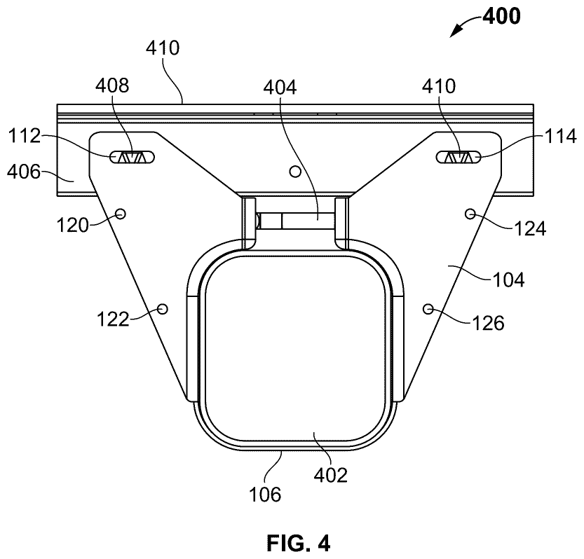

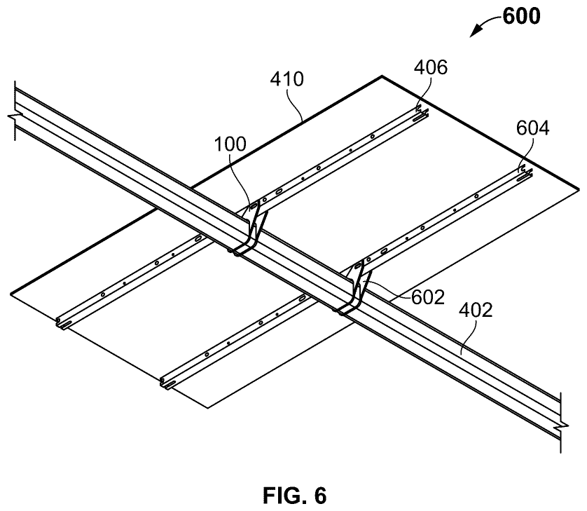

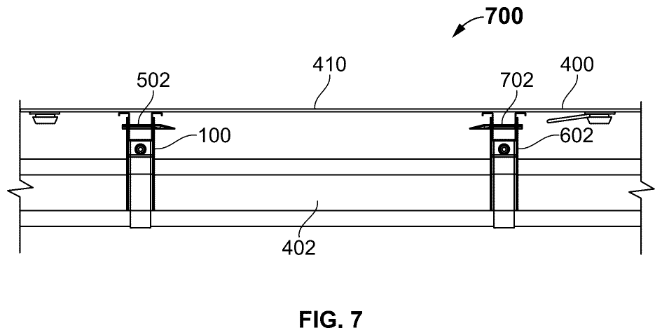

Referring now to FIG. 1, a perspective view of a panel rail for a solar mounting rack in accordance with one embodiment is shown generally at 100. The panel rail 100 comprises a front bracket 101 having front wing portions 102 and 104, a bottom rung 106 and front mounting slots 112 and 114, respectively, for attachment to the back rails of the thin film solar module (shown in relation to FIG. 6 and FIG. 7). The bottom rung 106 extends from the interior portions 108 and 110 and is configured to engage a toque tube of the assembly (shown in FIG. 4). The front bracket upper contours 116 and 118 are shaped to further engage and hold the torque tube (shown in relation to FIG. 4).

The wing portions 102 and 104 comprise front bracket holes 120, 122, 124 and 126 at upper ends of the wing portions 102 and 104. The front bracket holes 120, 122, 124 and 126 are configured as wire management holes, where “Christmas tree” wire management clips may be installed. Alternatively, they can be used to support wires via zip ties or other wire hook management solution.

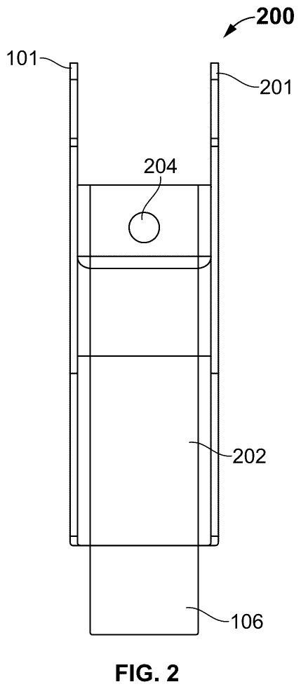

With reference now to FIG. 2 a side view of a panel rail for a solar mounting rack is shown at 200. The front bracket 101 is shown with the bottom rung 106, and a first side portion 202 of the rail 100 is shown. The first side portion 202 connects the front bracket and a back bracket 201. The front bracket 101 and back bracket 201 may also be referred to herein as first bracket and second bracket. A front side bolt hole 204 positioned in the wing portions 102 and 104 on the interior portions 108 and 110 thereof. A second side bolt hole is provided on other side portion concentric with the front bolt hole 204, but cannot be seen in this view 200. The front side bolt holes are configured to connect accept a carriage bolt and are thus square in shape, and to engage the torque tube and secure it to the rail.

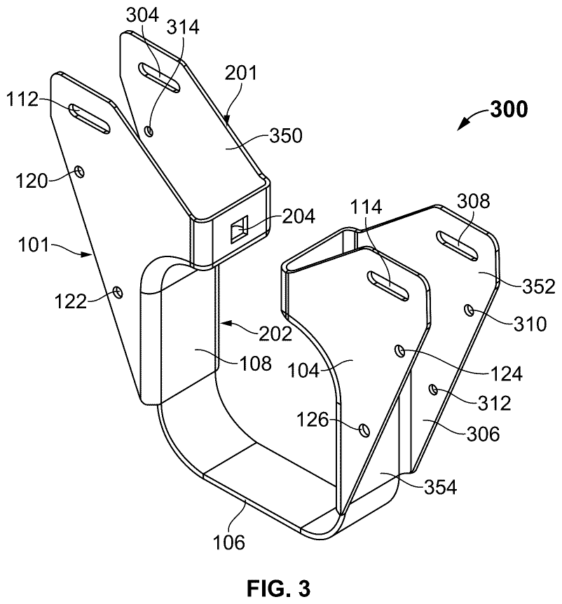

FIG. 3 illustrates a perspective view of a panel rail 100 for a solar mounting rack at reference numeral 300. In this view, front bracket 101 and back bracket 201 can be seen together with the inside portion of the bottom rung 106. The front bracket 101 and is connected to the back bracket 201 via first side portion 202, which has a predetermined depth such that there is a space between the front bracket wing 102 and the back bracket wing 350. The back bracket wing 350 and wing 352 each comprise back bracket wing bolt holes (310, 312, 314, and one not shown) that are congruent and in the same plane as front bracket wire management 120, 122, 124 and 126.

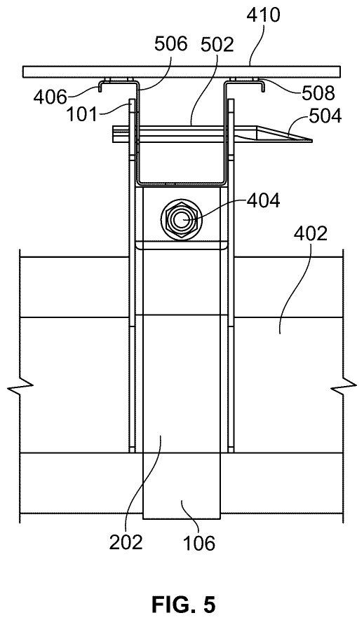

On the right (or other) side as shown in this FIG. 3, the front bracket 101 and is further connected to the back bracket 201 via second side portion 354, which has a predetermined depth the same as the first side portion 202 such that there is a space between the front bracket wing 104 and the back bracket wing 352. The space is configured such bolts can be easily place through the bolts holes 204 and wedge clips (shown in FIG. 5) can be placed through mounting slots 112, 114, 304 and 308. The back bracket 201 comprises back mounting slots 304 and 308, which are congruent and in the same plane as front mounting slots 112 and 114. In operation, wedge clips (shown with reference to FIG. 4 and FIG. 5) are configured to assist in connecting the solar module rails to the tracker assembly.

To this end, in this FIG. 3, the first side bolt hole 204 can be seen, and there is a second side bolt hole which cannot be seen in this view that is positioned congruent with and in the same plane as the first side bolt hole 204, which is configured to accept a top side bolt that will in turn help to hold the toque tube in place. The bolt hole 204 is positioned at a top end of the rail to secure the torque tube in a more ergonomically way for the installer. In operation, bottom rung 106 is securely wrapped around the torque tube when the bolt is tightened.

Referring now to FIG. 4, a front view of a panel rail together with a torque tube 402 and solar module on a solar mounting rack is shown generally at 400. In this embodiment, the rail 100 can be seen together with a portion of the tracker system connected to thin film modules. The brackets 102 and 104 are connected to the rails of a solar module 410 via wedge clips 404 and mounting slots 112 and 114. The bottom rung is positioned to hold a torque tube that can be installed between the brackets using bolt 404 that is tightened by the installer. The module rails 406 are connected to the wings of the rail 100 via wedge clips 408 and 410 using mounting slots 112 and 114 (on one side).

Referring now to FIG. 5, a side view of a panel rail together with a torque tube and solar module 410 on a solar mounting rack is shown. Wedge clip 502 is configured to slide through mounting slots 112 and 114 on one side and 114 and 308 on the other side. The wedge clip has a sloped point 504 on one side and provides an interference fit to help secure the rail 100 to the rail 406. For perspective, the inside of the rail 506 is also shown herein.

Referring now to FIG. 6, a bottom perspective view of a panel rail 100 solar together with a solar module 410 shown at 600. A first rail 100 is connected to brackets 101 and 201 shown in FIG. 3), and are connected to torque 108 via bottom rung 106 in the bottom side of the photovoltaic cell or solar module 410 can be seen together with rail 110. A second module rail 604 is shown herein 101 and 201 shown in FIG. 3), and are connected to torque 108 via bottom rung 106 on the bottom side of the photovoltaic cell or solar module can be seen together with rail 110.

Referring now to FIG. 7, a side view of a panel rail together with a solar module 410 in accordance with one embodiment is shown at 700. A second rail 602 and second wedge clip 702 is shown in this view.

In operation, the installer can secure the torque tube using the single bolt along the top surface of the torque tube (rather than bolting together multiple pieces at a bottom side). As the bolt is located at eye level, it is more ergonomic to install than securing the fastener below the torque tube.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

We claim:

1. A panel rail for a solar mounting system, the panel rail comprising:
a front bracket, wherein the front bracket comprises:
a front wing portion;
a front mounting slot positioned proximate top end of the front wing portion;
a back bracket, wherein the back bracket comprises:
a back wing portion;
a back mounting slot positioned proximate top end of the back wing portion;
a bottom rung positioned at a bottom portion of the panel rail, wherein the bottom rung is configured to engage a torque tube;
a side portion extending upwardly from the bottom rung, wherein the side portion is coupled to each of the front wing portion and back wing portion, and wherein the side portion comprises a bolt hole;
wherein the side portion is configured to accept a bolt through the boat holes to engage a torque tube, and
wherein the mounting slots are configured to connect a solar module to the panel rail.

2. The panel rail of claim 1, wherein:
the front wing comprises a front left wing and a front right wing;
the front right wing comprises the front mounting slot, and a front left mounting slot;
the back wing comprises a back left wing and a back right wing;
the back right wing comprises a back right mounting slot, and a back left mounting slot; and
the mounting slots are configured accept a wedge clip, wherein the wedge clip is configured to couple the solar module the rail.

3. The panel rail of claim 1, wherein the front racket and backet bracket comprise upper contours that are shaped to further engage the torque tube.

4. The panel rail of claim 1, wherein the front bracket and back bracket both comprise a plurality of holes, and wherein the holes are configured to manage wires of an electrical assembly of the solar modules.

5. The panel rail of claim 1, wherein the side portion comprises a first side portion and a second side portion, each of which extends from the bottom rung, and wherein the second side portion comprises a second bolt hole configured to accept the bolt to engage the torque tube.

6. The panel rail of claim 5, wherein the first side portion and second side portion are sandwiched by the front bracket and back bracket and have a predetermined depth, and wherein each of the wing portions extend outwardly from the side portions to form a space between each of the front bracket wings and back bracket rings.

7. The panel rail of claim 1, wherein in the first and second bolt holes are square shaped, and wherein the bolt comprises a carriage bolt.

8. The panel rail of claim 2, wherein:
the front left mounting slot is congruent with and in a same plane with the back left mounting slot;
the front right mounting slot is congruent with and in a same plane with the back right mounting slot;
wherein the front right mounting slot and back right mounting slot is configured to accept a second wedge clip, wherein the second wedge clip is further configured to accept a second wedge clip, wherein the second wedge clip is configured to further couple the solar module the rail.

9. The panel rail of claim 1, wherein the wedge clip has a sloped point on one side and is conjured to provide an interference fit to secure the rail to the solar module.

10. The panel rail of claim 1, wherein the panel rail comprises a plurality of panel rails for use with a solar power farm.
